(19) United States
(12) Patent Application Publication
(10) Pub. No.: US 2004/0129234 A1
(43) Pub. Date: Jul. 8, 2004

(54) Pet carrier

(76) Inventor: Guy R. Beretich SR., Clinton, NC (US)

Correspondence Address: JINAN GLASGOW, P O BOX 28539, RALEIGH, NC, 276118539

(21) Appl. No.: 10/335,820

(22) Filed: Jan. 2, 2003

(51) Int. Cl. A01K 1/03

(52) U.S. Cl. 119/497

(57) ABSTRACT

A pet carrier for small animals, including a sliding top, a stackable base, at least one handle and a top-retaining mechanism, that facilitates handling of animals by allowing their retrieval from behind and above. The stackable base allows compact storage of multiple bases without disassembly of the bases.

### BACKGROUND OF THE INVENTION

1. Field of the Invention

The present invention relates generally to an apparatus for the transportation of animals and, more particularly, to a hand carrier for small animals.

2. Description of the Prior Art

Animals that are being carried to new locations are frequently frightened and may react violently to a stranger or even their owner when the person is reaching into the carrier to grasp the animal to remove it from the carrier. They may bite or claw the person trying to grasp them. Therefore, pet carriers need to be configured such that the animal handler is not placed in an unduly unsafe position when grasping the animal and the animal is not unduly stressed when handled.

Prior art pet carriers commonly employ cages that can open only from one end, generally from the front. The end-openings are in the normal field of view of an animal housed within, and thus the animal can readily see the opening and anything moving through the opening. Therefore, these prior art carriers tend to place the animal handler in an unsafe position.

The prior art also frequently uses hinged doors, which create large escape routes for the animal when opened to allow a handler to insert his/her hand and arm. Furthermore, these hinged doors generally allow opening in only one direction.

Keeping an animal calm during handling is not only a benefit to the handler, but also to the animal. Calm animals do not injure themselves as frequently as agitated animals.

Prior art cages are not conveniently stackable, but must be dismantled and/or folded to be stacked for storage. Thus, these carriers both require time for assembly and are frequently assembled prior to use, thereby occupying more space. Compact storage of equipment is important, especially in professional offices such as veterinary offices, where space is not frequently plentiful. Also reduced assembly time is also important to reduce costs associated with supplying the carriers.

Thus a need exists for a pet carrier that allows an animal to be grasped by a handler with little agitation and does not offer visible escape routes to the animal.

Furthermore, there remains a need for a pet carrier that is conveniently stackable without being dismantled.

### SUMMARY OF THE INVENTION

The present invention is directed to a pet carrier for small animals that facilitates their retrieval without undue agitation as well as providing a pet carrier that is conveniently stackable without being dismantled.

Accordingly, one aspect of the present invention is to provide a pet carrier, composed of a sliding top, a stackable base, at least one handle attached to the base, and a top-retaining mechanism, thereby facilitating the handling of animals by allowing retrieval of animals from behind and above and allowing compact storage.

These and other aspects of the present invention will become apparent to those skilled in the art after a reading of the following description of the preferred embodiment when considered with the drawings.

### BRIEF DESCRIPTION OF THE DRAWINGS

FIG. 1 is a perspective view of a pet carrier constructed according to the present invention.

FIG. 2 is a transparent perspective view of the pet carrier of FIG. 1.

FIGS. 3 through 9 are cross-sectional end views of alternative embodiments showing the top-retaining mechanisms and the angle α.

FIG. 10 is a cross-sectional side view of an embodiment showing the angle α.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

Referring now to the drawings in general, the illustrations are for the purpose of describing a preferred embodiment of the invention and are not intended to limit the invention thereto.

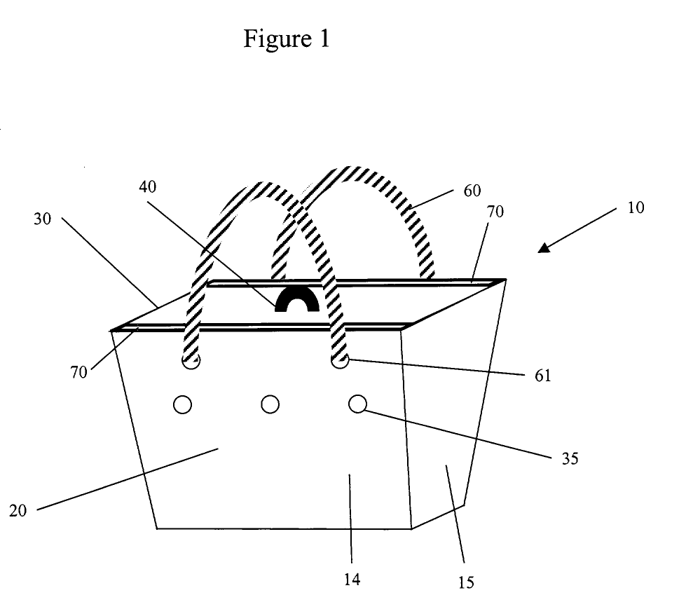

As best seen in FIG. 1, the pet carrier, generally referenced as 10, includes a base 20, a sliding top 30, and at least one handle 60. More specifically, the pet carrier is composed of a top 30 and a stackable base 20 having a top-retaining mechanism 70 and at least one handle 60 attached to the base, wherein the top is slideably interconnected to or engaged with the stackable base via the top-retaining mechanism, thereby providing a pet carrier that facilitates the handling of animals by allowing retrieval of animals from behind and above and stores compactly.

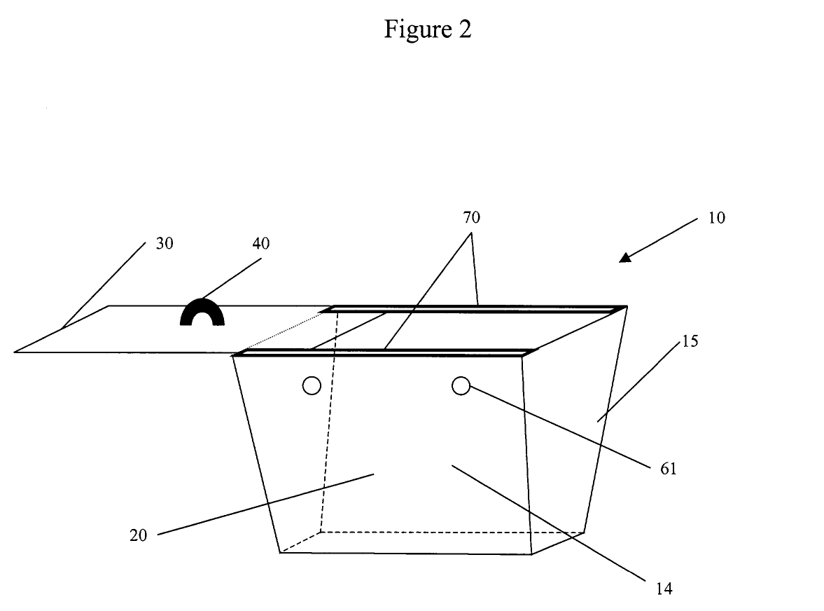

As shown more clearly in FIG. 2, the sliding top allows the carrier to be opened from either end. The handles have been omitted from FIG. 2 for clarity. Preferably, the sliding top can be opened from either end facilitates removal of the animal, because the animal handler can first determine the orientation of the animal in the carrier, then slide the top in the direction that will allow the handler to grasp the animal more safely from behind, preferably by the neck. Visualization holes 35 can be included in the base or top to allow the handler to peer into the carrier and determine the orientation of the animal and also serve as air holes for the animal contained within. The top may include a top handle 40 to facilitate sliding the top.

The at least one handle is preferably detachable from the carrier base to facilitate stacking. In a preferred embodiment, the at least one handle is a flexible handle, such as a rope or strap that can be attached to the base by inserting the ends into the base through a handle hole 61 in the base and then enlarging the ends such that the end can no longer exit through the handle hole. For example, a knot may be formed in the end or an object larger than the handle hole affixed to the end. Alternatively, the ends may be attached to one another inside the base, either the ends from the same handle or either of the ends from an opposite handle.

Because animals do not routinely look up and behind their head, the animal will generally not see the hand coming to grasp it. The handler also preferably only opens the top enough to insert his/her hand and forearm, thus not creating a possible escape route in the normal field of vision of the animal. Because the handler's hand will not be visible and no apparent route of escape will be visible to the animal when the carrier is opened in this manner, the animal will not become agitated as it would if it were seeing a hand coming toward it to grasp it through a possible escape route. Therefore, the animal will remain tranquil and allow the handler to quickly and easily grasp the animal from behind, preferably by the neck.

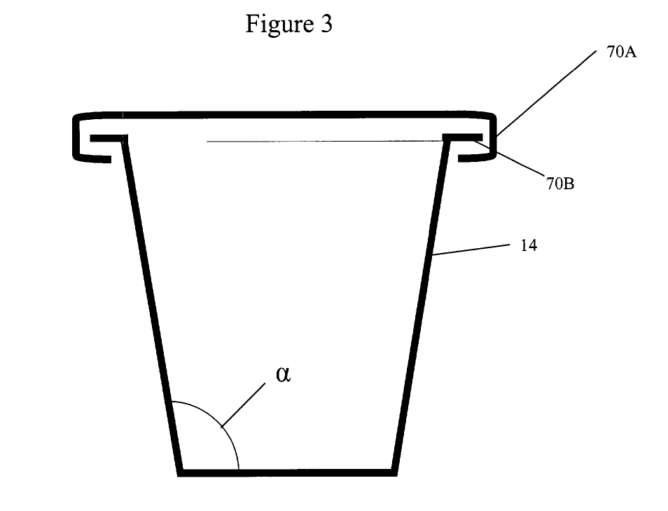

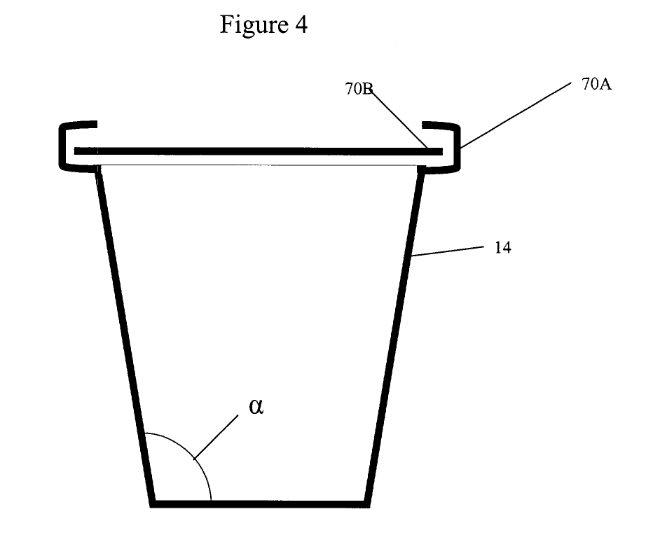

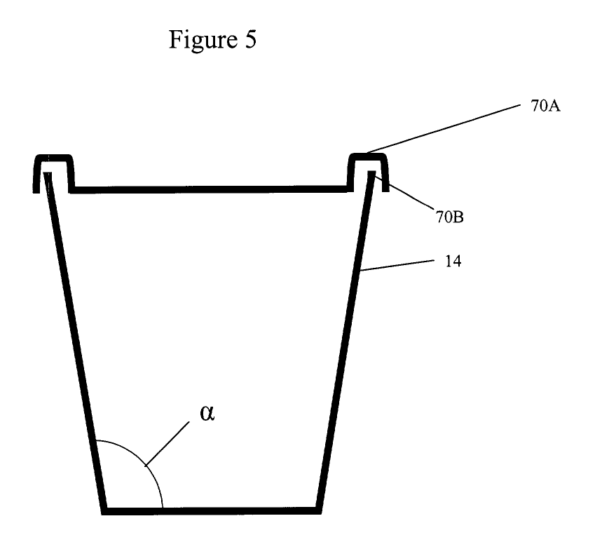

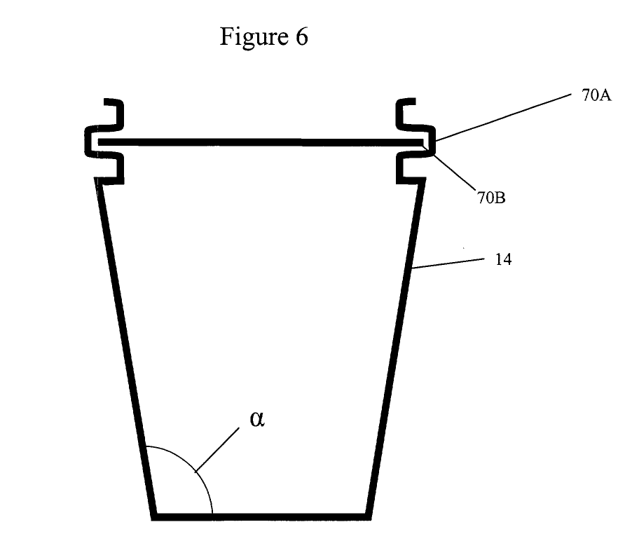

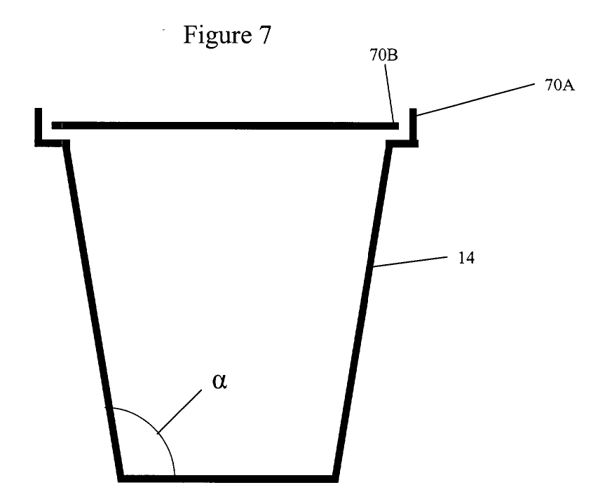

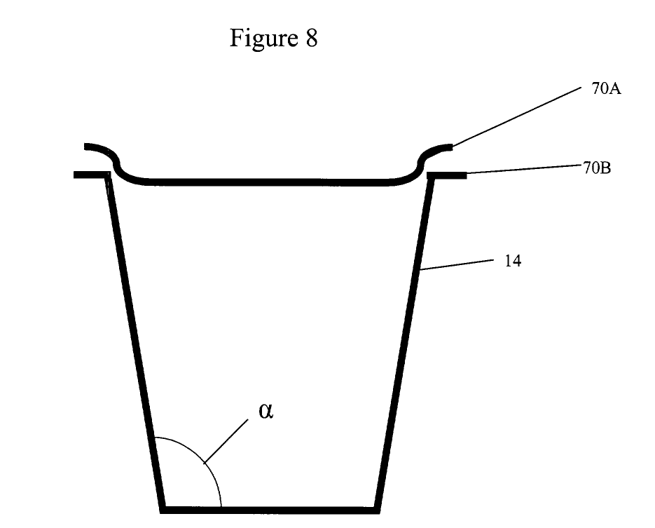

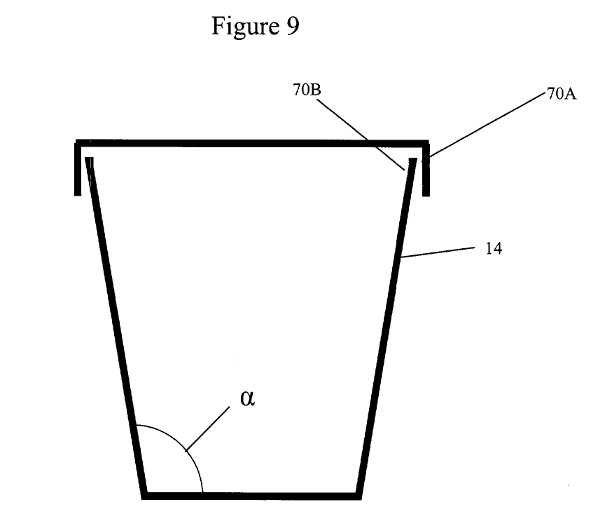

The sliding top is preferably retained by a top-retaining mechanism 70, shown as 70A and 70B in FIGS. 3 through 9. As can be seen in the various embodiments, the top-retaining mechanism can be a tongue-in-groove-type mechanism or similar pattern of complementary and/or mating shapes, as seen in FIGS. 3 through 6, wherein the groove is illustrated in the top or, alternatively, in the base portion. The mating engagement preferably occurs at the edges of the top and the top portion of the sides of the base. Another embodiment is a mating flange-type mechanism, which allows the top to rest on the base, without being retained by a groove, as seen in FIGS. 7, 8 and 9. The top can then be fixed to the base by a variety of mechanisms, including, latches, straps, hook-and-loop fasteners, such as VELCRO, and the like.

The top can be segmented, such that only a portion of the top need be slid to allow access to the animal within. In one embodiment, this segmentation provides for a central portion of the top to be slideable engaged with surrounding portion of the top in a mating manner, as set forth hereinabove for the top and base slideably mating relationship. Alternatively or additionally, the segmented lid may be further subdivided to provide for smaller, predetermined opening options.

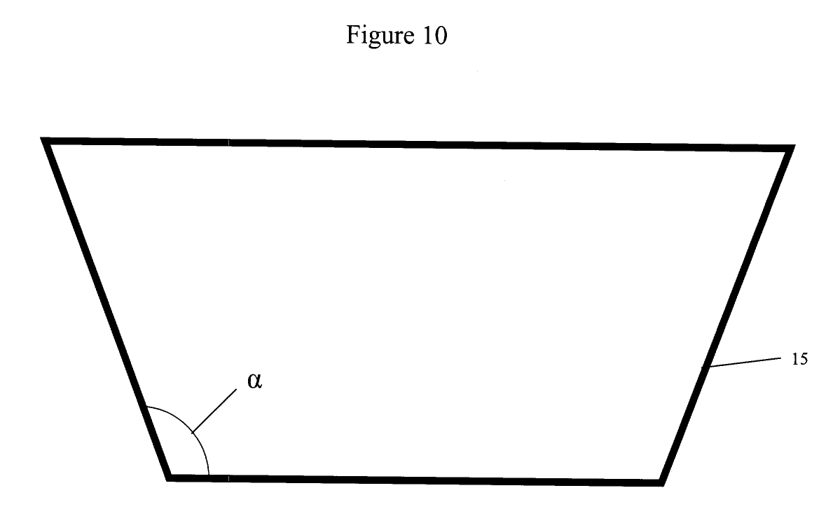

A second feature of the pet carrier according to the present invention is the stackable nature of the body of the carrier. As shown in FIGS. 3 through 9 and FIG. 10, the carrier sides 14 and ends 15, respectively, are angled inward from top to bottom at an angle α and the top-retaining mechanisms 70 are designed such that multiple carriers without installed tops can be nested and thereby stacked. The handles are preferably removable to allow the bases to stack more compactly. Importantly, the top-retaining mechanisms of the base, as shown in FIGS. 3 through 9, are designed such that they do not project into the top opening of the base and thus do not interfere with the sides of a base stacked within. The angle α of the sides and ends are such that the carrier bases can be stacked. Although shown in the drawings as the same angle α, the angle for the sides and ends can be different.

A broad range of angles can allow the bases to be stacked; generally any angle greater than 95 degrees will suffice to allow the bases to stack. Preferably, the angle should be closer to 90 degrees rather than more obtuse, to prevent the animal from attempting to climb the sides of the carrier base. More preferably, the angle should be about 100 degrees to allow the carriers to be stacked and provide a stabile carrier base.

The top can also be used for personalization and/or messaging, including advertising, records, and reminders. The ability to easily remove the top also allows it to be readily exchanged with another top containing different messaging. Alternately, records and reminders can be written on the top in permanent ink. The top can then be replaced when necessary or the writing erased with a solvent, such as alcohol or acetone. The planar shape of the top allows it to be readily printed upon or embossed or otherwise marked, especially with large characters, such as logos and images.

Certain modifications and improvements will occur to those skilled in the art upon a reading of the foregoing description. By way of example, the handles can be of various lengths. Longer handles can be provided such that the carrier can be easily lifted and carried a few inches from the floor, eliminating the need to bend over to lift the carrier. Also, wheels can be added to the base to facilitate moving a heavy animal. All modifications and improvements have been deleted herein for the sake of conciseness and readability but are properly within the scope of the following claims.

I claim:

1. A pet carrier, comprising:
a top,
a stackable base having a top-retaining mechanism and
at least one handle attached to the base,
wherein the top is slideably engaged with the stackable base via the top-retaining mechanism,
thereby providing a pet carrier that facilitates the handling of animals by allowing retrieval of animals from behind and above and stores compactly.

2. The pet carrier of claim 1, wherein the top-retaining mechanism includes a fastener.

3. The pet carrier of claim 2, wherein the fastener is a hook-and-loop fastener.

4. The pet carrier of claim 1, wherein the top-retaining mechanism is a tongue-in-groove-type mechanism.

5. The pet carrier of claim 1, wherein the top-retaining mechanism is a mating-flange-type mechanism.

6. The pet carrier of claim 1, wherein the stackable base has side and end angles α greater than about 95 degrees.

7. The pet carrier of claim 6, wherein the side and end angles α are about 100 degrees.

8. The pet carrier of claim 1, wherein the top includes a handle to facilitate sliding the top.

9. The pet carrier of claim 1, wherein the top includes a messaging area.

10. The pet carrier of claim 1, wherein the at least one handle is two handles.

11. The pet carrier of claim 1, wherein the top-retaining mechanism provides a mating engagement between the stackable base and the top.

12. The pet carrier of claim 11, wherein the mating engagement occurs at the edges of the top and sides of the base.
